(19) United States
(12) Patent Application Publication
(10) Pub. No.: US 2026/0021570 A1
(43) Pub. Date: Jan. 22, 2026

(54) Storage Device

(71) Applicant: TANOS GmbH, Illertissen (DE)

(72) Inventor: Martin Olbrich, Holzheim (DE)

(21) Appl. No.: 18/871,539

(22) PCT Filed: Jul. 12, 2023
(86) PCT No.: PCT/EP2023/069297

§ 371 Date: Dec. 4, 2024

(51) Int. Cl. B25H 3/02; A45C 5/02; A45C 13/02; A45C 13/26; A45C 13/42; A45F 3/02

(52) U.S. Cl. CPC B25H 3/02; A45C 5/02; A45C 13/02; A45C 13/26; A45C 13/42; A45F 3/02

(57) ABSTRACT

A storage device with a storage bag, which has a bag body with a bag bottom and a bag circumferential wall protruding in a vertical direction from the bag bottom, which together delimit a storage space open at the top of the bag, and with a carrying handle spanning the storage space and attached to the bag body in the region of the top of the bag, and wherein the bag circumferential wall is fastened to the bag bottom, the bag bottom has a base plate and the storage bag has a guide device on the outer side of the base plate, over which the storage bag can be pulled out in a pulling-out direction, able to be held in a shelf structure belonging to the storage device.

### CROSS-REFERENCE TO RELATED APPLICATION

This application is the United States national phase of International Patent Application No. PCT/EP2023/069297 filed Jul. 12, 2023, the disclosure of which is hereby incorporated by reference in its entirety.

### BACKGROUND

### Field

The invention relates to a storage device with a storage bag, which has a bag body with a bag bottom and a bag circumferential wall protruding in a vertical direction from the bag bottom, which together delimit a storage space open at the top of the bag, and with a carrying handle spanning the storage space and attached to the bag body in the region of the top of the bag, and wherein the bag circumferential wall is fastened to the bag bottom.

Storage bags, in particular in the form of tool bags, have long been known. In contrast to storage containers for example in the form of toolboxes or tool containers, such tool bags are considerably less bulky, because for the most part, they have a flexible bending bag body. Tool bags are used to hold and keep all kinds of tools. The tools are mostly hand tools, for example screwdrivers or suchlike.

### Description of Related Art

A storage device with a storage bag of the type mentioned at the beginning is described for example in U.S. Pat. No. 7,780,051 B2. The toolbag disclosed therein has a flexible case with a flexible bag bottom, wherein the toolbag is provided with a central separation wall protruding in a vertical direction, which stiffens the flexible case. A carrying handle is arranged with the flexible case on two flaps at the top of the bag.

A toolbag is disclosed in WO 2004/031054 A1, which has a rigid bag bottom like a wall, which is joined by means of joining means in the form of press-studs to a bag case tensioned over it. The bag case in a flexible material is closed at the top of the bag by means of diverse zip fasteners. The toolbag furthermore has a central separation wall, at the top of which a carrying handle is arranged, wherein the separation wall is also joined to the wall-like bag bottom by means of joining means in the form of rivets.

DE 20 2018 100 183 U1 describes a shelf system, which has at least one container that can be moved over guide elements like rails from a retracted rear position to an extended front position along a pull-out direction, wherein the front and rear positions are each defined by stops.

### SUMMARY

The aim of the invention is to provide a storage device of the kind mentioned at the beginning, which is more versatile to manage compared with the storage devices known in the prior art, in particular portable, safely stowed on a service vehicle.

This aim is achieved by a storage device with the characteristics of independent claim 1. Further developments of the invention are described in the subclaims.

The storage device according to the invention is characterised by the fact that the bag bottom has a base plate and the storage bag has a guide device on the outer side of the base plate, over which the storage bag can be pulled out in a pulling-out direction, able to be held in a shelf structure belonging to the storage device.

The rigid base plate with the guide device makes it possible to house storage bags consisting per se of a bending flexible material on a shelf structure or shelf system. One and the same shelf system can thereby be used to store rigid containers and also to store such holding bags.

In a further development of the invention, the base plate has a rectangular contour, with a front face, a back face arranged opposite this one and two side faces arranged opposite each other.

The guide device particularly preferably has two guide units formed on the side faces of the base plate.

In a particularly preferable manner, the guide units are formed in a single piece with the remainder of the base plate.

The base plate and the guide units can consist of a plastic material, for example, the base plate and the guide units can be a one-piece injection moulded plastic part.

In a further development of the invention, the guide units each have a back stop and a front stop for attaching the storage bag in a defined rear position and when moved in a pulling-out direction, in a defined front position.

It is possible for the guide units each to have a recess for accommodating a guide bar formed on the shelf structure.

Particularly preferably, the front stop and the back stop are arranged below the recess.

In a further development of the invention, in addition to the storage bag, the storage device has at least one storage container having a storage casing, wherein a lower coupling device is arranged on the base plate of the storage bag and an upper coupling device is arranged in the region of a top side of the container casing of the storage container, wherein these two coupling devices are matched together such that the storage bag stacked on the storage container in a vertical direction can be detachably coupled together in an inseparable manner by interaction of the upper coupling device of the holding container with the lower coupling device of the storage bag.

In a particularly preferred manner, the lower coupling device on the base plate of the holding bag has a locking projection arranged on the front face of the base plate and the upper coupling device on the container casing has a twist lock, which can be moved for locking in locking engagement with the locking projection.

In a further development, the bag bottom has a clamping element attached on the upper side of the base plate, wherein a fastening flaps arrangement in a bending flexible material protruding inwards on the bag circumferential wall is arranged on its underside, and is fixedly clamped between the base plate and the clamping element.

The bag circumferential wall and the bag bottom can be positively joined in a vertical direction, since the fastening flaps arrangement is clamped between the clamping element and the base plate. If the user therefore takes hold at the bag circumferential wall instead of handling the carrying handle, and lifts a fully laden storage bag, the bag circumferential wall is nevertheless reliably secured to the bag bottom. Such securing is relatively simple and quick to achieve by clamping between a clamping element and a base plate.

In a further development of the invention, the bag circumferential wall has a textile body. A water repellent textile material is expediently used in this case.

In a particularly preferred manner, a stiffening structure is enclosed in the textile body. The bag circumferential wall thereby receives stiffening, which means that it is inherently stable in shape. The stiffening structure has several stiffener plates or stiffener bars enclosed by the textile body.

It is particularly preferable to form the fastening flaps arrangement in a single piece on the textile body. The fastening flaps arrangement is therefore expediently also made from a textile material.

In a further development of the invention, the fastening flaps arrangement has several fastening flaps formed separately from each other. It is thereby possible easily to fold the lower end of the bag circumferential wall inwards, so that it is available as a fastening flap arrangement with the several fastening flaps for clamping between the clamping element and the base plate.

In a further development of the invention, the bag bottom has attachment elements for positive attachment of the fastening flaps arrangement in a bag plane orthogonal to the vertical direction.

In a particularly preferred manner, the attachment elements are formed as attachment pins piercing the fastening flaps arrangement and arranged on the base plate or on the clamping element. The attachment pins, which can also be designated fixing pins, are expediently arranged on the underside of the clamping element, there for example in one piece.

In a particularly preferred manner, the clamping element is formed as a clamping plate. The bag body in such a configuration is configured as a double-walled bottom with the base plate and the clamping plate. The clamping plate substantially completely covers the upper side of the base plate. Alternatively, it is however also conceivable for the clamping element to be configured as a frame-shaped clamping frame.

In a further development of the invention, the bag bottom has a fastening device for reciprocal tensioning of the base plate with the clamping element. The fastening device preferably has a multiplicity of fastening screws, which are supported on the base plate or on the clamping element and into which other components can respectively be screwed. However, fastening devices would also be conceivable, which are adapted for tensioning the base plate and clamping element without tools, for example snap, latch or clip fasteners.

In a particularly preferred manner, the bag circumferential wall forms a rectangular contour and is formed from two side walls arranged opposite each other, a front wall and a back wall.

In a particularly preferred manner, a separation wall is provided that extends in a vertical direction and divides the storage space into two storage compartments. In the case of a bag circumferential wall with a rectangular contour, the separation wall is expediently located between the front wall and the back wall. The separation wall can also have a textile body, which can be stiffened by a stiffening structure.

In a particularly preferred manner, the separation wall is fastened to the bag bottom in the region of its underside facing the bag bottom by means of a separation wall fastening device.

In a particularly preferred manner, the separation wall fastening device comprises a piping strip arranged on the separation wall and a holding unit arranged on the bag bottom holding the piping strip and a wall section of the separation wall enclosing the piping strip. The holding unit is expediently located on the clamping plate. The holding unit can for example be formed by a holding rail extending in a longitudinal direction between the two side walls or by several holding segments arranged one after another in a longitudinal direction, wherein the holding rail or if applicable the holding segments are slotted on their upper sides facing the holding space, so that the wall section of the separation wall passes through the slot when inserted sideways, but not the piping strip in a hollow space of the holding rail or holding segment.

In a further development of the invention, the upper side of the separation wall is formed with the carrying handle below and a carrying handle/separation wall/bag bottom assembly is formed by the join with the bag bottom. The assembly can be handled as a unit, wherein expediently, only the clamping plate from the bag bottom belongs to the assembly.

It is possible for the carrying handle to be formed by two handle plates with their respective open sides opposite each other and joined together. The handle plates can be formed for example like half shells.

The carrying handle is expediently formed as a bow handle with a grip bar extending between two sides of the handle. The grip bar can then be grasped easily by the hand of the user and enclosed by the fingers.

The upper side of the separation wall particularly preferably has a joining rod, which is arranged in a hollow space formed by the two handle plates and is held by the tension of the handle plates, acting to secure the separation wall on the carrying handle.

In a particularly preferred manner, the carrying handle is joined to the bag circumferential wall by a joining device. The carrying handle is preferably joined to both opposite side walls of the bag circumferential wall. It is possible for the joining device to have joining elements respectively associated with the side walls, joining devices that are attached on one hand to the side wall of the bag circumferential wall and on the other, clamped to a flap between the two handle plates.

In a further development of the invention, several holding elements for holding items like tools or suchlike are provided on the inner side of the bag circumferential wall and/or on at least one side face of the separation wall facing the associated holding compartment.

The holding elements expediently each have a holding section formed in the shape of a loop or pocket. If necessary, the holding section can be a rubber elastic material, which produces the holding strength for the item to be held.

In a further development of the invention, the holding elements have a plate-shaped base section, by means of which the holding element can be detachably fastened or is detachably fastened by means of a joining device to the associated inner side of the bag circumferential wall and/or the side face of the separation wall.

In a particularly preferred manner, the joining device is formed as a reversible quick-release fastener, in particular a textile Velcro fastener.

In a further development of the invention, a carrying strap is provided and is fastened in particular to the bag circumferential wall. This allows the user to shoulder-carry the storage bag.

### BRIEF DESCRIPTION OF THE DRAWINGS

The terms Fig., Figs., Figure, and Figures are used interchangeably in the specification to refer to the corresponding figures in the drawings.

A preferred embodiment example is illustrated in the drawing and is described in more detail below. The drawing shows:

FIG. 1 a perspective illustration of a preferred embodiment example of the storage device according to the invention, FIG. 2 a perspective view of the storage device of FIG. 1, from below onto the base plate,

FIG. 3 an exploded view illustrated in perspective of the disclosure device of FIG. 1, diagonally from above,

FIG. 4 an exploded view shown in perspective of the storage device of FIG. 1, from below,

FIG. 5 a section through the storage device of FIG. 1 along the line V-V of FIG. 1,

FIG. 6 a perspective, partially sectional illustration of the storage device of FIG. 1 with a sectioned bag circumferential wall and separation wall,

FIG. 7 a longitudinal section through the storage device of FIG. 1, along the line VII-VII, and

FIG. 8 a perspective illustration of an embodiment of a holding element used in the storage device of FIG. 1.

### DETAILED DESCRIPTION

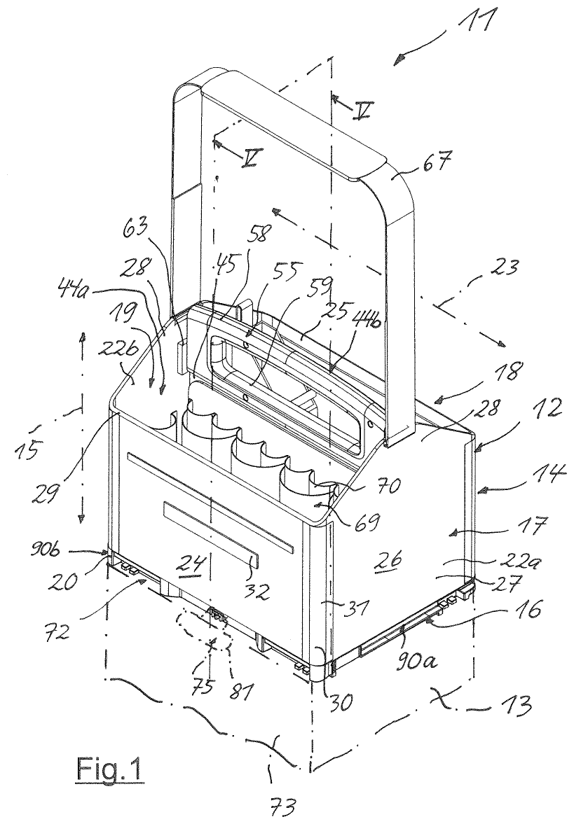

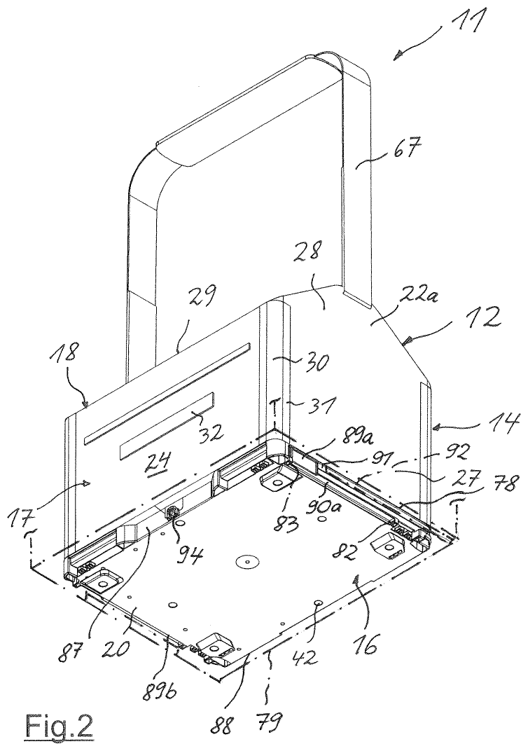

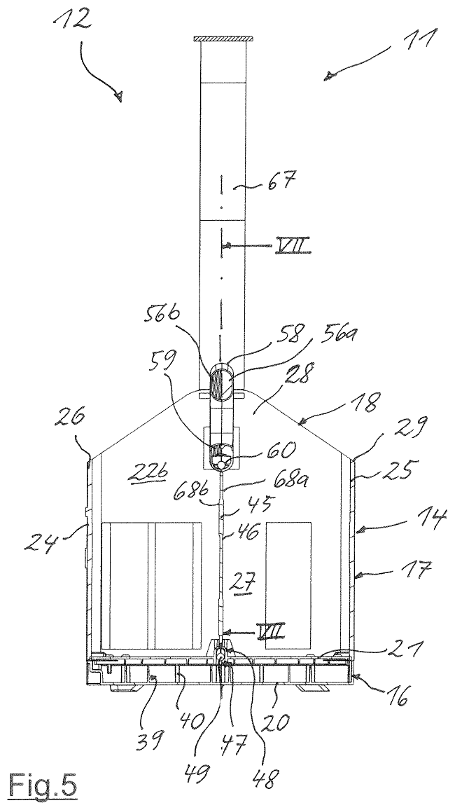

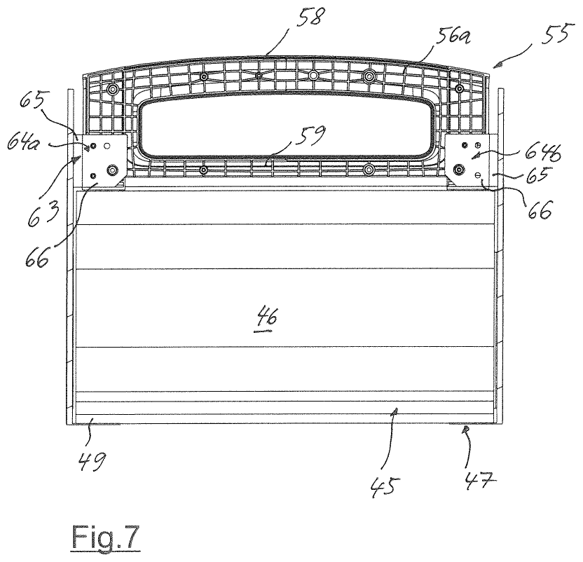

FIGS. 1 to 8 show a preferred embodiment example of the storage device 11 according to the invention, which, in the example shown, comprises a storage bag 12.

As shown in FIG. 1 by dotted lines, the storage device 11 in addition to the storage bag 12 can further comprise at east one storage container 13. The storage bag 12 of the storage device 11, described in more detail below is designed as a tool bag in the example shown. It is possible of course also to use the storage bag 12 for other uses than for transporting tools.

As shown in particular in FIGS. 1 to 4, the holding bag 12 has a bag body 14, which is configured in a cuboids shape in the example shown, therefore has a rectangular contour. The bag body 14 has a bag bottom 16 and a bag circumferential wall 17 protruding in a vertical direction 15 from the bag bottom 16, which jointly delimit a storage space 19 open at a bag top 18.

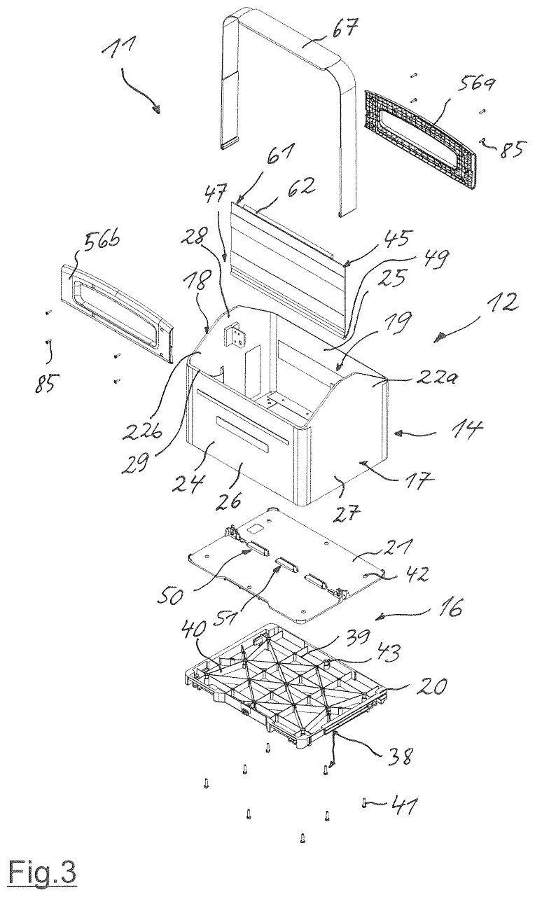

As shown in particular in FIG. 3, the bag bottom 16 has a base plate 20, which forms the lower closing end of the storage bag 12. The bag bottom 16 furthermore has a clamping element 21, which is configured in the example shown as a clamping plate. The base plate 20 described in more detail below and the clamping plate have a rectangular contour in the example shown.

Such a bag bottom consisting of a base plate and a clamping plate could also be designated “double bottom”.

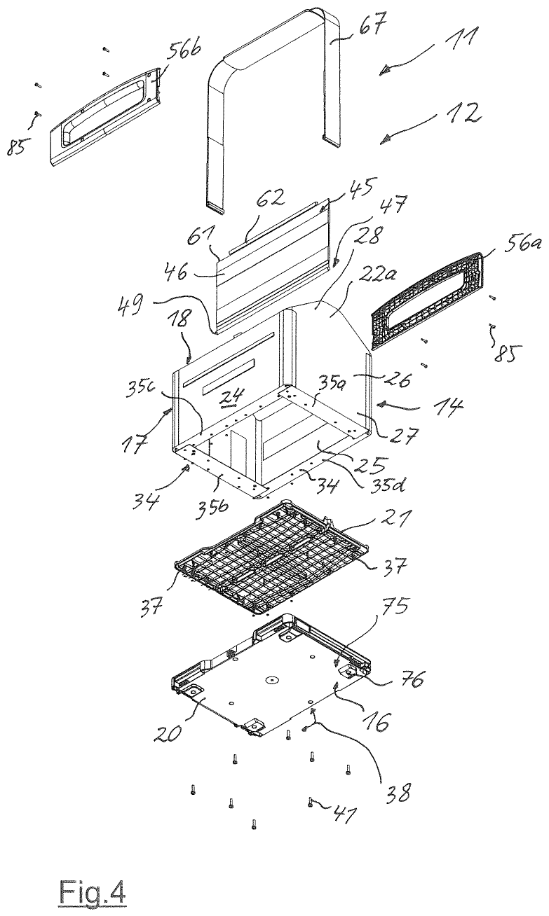

As shown in particular in FIG. 4, the bag circumferential wall 17 in the example shown has a rectangular contour. The bag circumferential wall 17 in this case consists of two side walls 22a, 22b situated opposite each other and a front wall 24 and a back wall 25 extending in a longitudinal direction 23 of the storage bag 12, running between the two side walls 22a, 22b. The front wall 24 and the back wall 25 are aligned parallel to each other along the longitudinal direction 23.

The bag circumferential wall 17 has a textile body 26. In the example shown, the two side walls 22a, 22b, the front wall 24 and the back wall 25 therefore each have a textile body 26. The textile body 26 expediently forms the inner side and the outer side of the respective walls. A water-repellent textile material is expediently used at least on the front side of the bag circumferential wall 17.

A stiffening structure (not illustrated) enclosed by the textile body is provided to stiffen the bag circumferential wall. The stiffening structure is expediently materialised by stiffener plates, which are enclosed by the textile body 26, in particular held in the textile body if the textile body consists of two layers, for example an inner and an outer layer. In this case, the stiffening structure is then situated between the inner and the outer layer. The stiffening structure is then expediently provided both on the side walls 22a, 22b and also on the front wall 24 and the back wall 25.

As shown in particular in FIG. 3, the front wall 24 and the back wall 25 are rectangular in shape. The two side walls 22a, 22b in contrast deviate from the rectangular basic shape, as each one has a side wall base section 27 and a side wall pediment section 28 provided in a single piece on the upper side of the side wall base section 27. The side wall pediment section 28 protrudes beyond the upper edge 29 of the front wall 24 and the back wall 25.

In order to produce the bag circumferential wall 17, a flat two-dimensional folding cut-out is first expediently prefabricated, in which all walls are already present. The folding cut-out can then be folded into a three-dimensional structure, wherein the ends of the folding section situated opposite each other are joined together by a corner connector (not illustrated). Alternatively, it is also theoretically conceivable to prefabricate the individual wall parts singly, to set them up three-dimensionally and then to join them with corner connectors at their joints or corners to make the bag circumferential wall 17.

As further shown in FIGS. 3 and 4, edge protection elements 30, which are expediently formed as fabric strips 31, are respectively provided at the corners between the wall parts, therefore between the front wall 24 and the two associated side walls 22a, 22b and the back wall and the two associated side walls 22a, 22b, the protection elements being joined to the side walls 22a, 22b and the front wall 24 on one hand or to the back wall 25 and the side walls 22a, 22b, in particular sewn there.

Although not explicitly illustrated in the drawing figures, it is possible to provide both the front wall 24 and the back wall 25 and also the side walls 22a, 22b with additional storage options, for example additional holding pockets, which can be closed if necessary by zip fasteners.

It is furthermore possible to provide an information box 32, in particular on the front wall 24, which is in the shape of a bar in the example shown. The information box can be made as a holder with its front side covered with a transparent film for holding or inserting a printed information label. Alternatively, it is possible for the information box 32 to have a base section attached to the associated wall, whose front side supports part of a reversible quick-release fastener, in particular a Velcro fastener. Used as a counterpart to this then is a material strip, in particular a textile material, with the information printed on the front side, and whose back side supports the other part of the reversible quick-release fastener and which can therefore easily be attached to the base section.

An important aspect of the invention is that an inward-protruding fastening flaps arrangement 34 in a bending flexible material, which is fixedly clamped between the base plate 20 and the clamping element 21, is arranged on the underside 33 of the bag circumferential wall 17.

In the example shown, the fastening flaps arrangement 34 has several fastening flaps 35a-d separate from each other, which are arranged respectively on the underside of the respective associated wall, therefore on the front wall 24, the back wall 25 and the two side walls 22a, 22b.

The fastening flaps 35a-d can be made at the same time as the two-dimensional folding cut-out is prefabricated, so that they can easily be folded inwards when forming the three-dimensional bag circumferential wall. The fastening flaps 35a-d are also expediently made in one piece with the textile body 26 of the different walls and also consist of a textile material.

The bag bottom 16 has attachment elements 37 for positive attachment of the fastening flaps arrangement 34 in a bag plane orthogonal to the vertical direction 15.

The attachment elements 37 are formed as attachment pins arranged on the base plate 20 or on the clamping plate, which pierce the fastening flaps arrangement 34 and therefore the fastening flaps 35a-d.

As shown in particular in FIG. 4, the attachment pins are situated on the underside of the clamping plate. The attachment pins make it possible to pierce the material of the fastening flaps 35a-d. It is however furthermore possible to provide the fastening flaps with through holes, through which the attachment pins can protrude. The attachment pins or fixing pins on the clamping plate are arranged on the underside in the edge region of the clamping plate, in particular circumferentially with regular spacing.

The bag bottom 16 has a fastening device 38 for reciprocal tensioning of the baseplate 20 with the clamping plate.

As shown in particular in FIG. 3, the upper side of the clamping plate is flat, while having a web structure on the underside. The upper side of the bottom base plate 20 also has a structured configuration and also has a web structure 39 with several in particular hollow webs 40 running laterally. The configuration of the web structure 39 on the base plate 20 is made mainly for weight-saving reasons, since a solid-bodied base plate would be heavier. This weight saving is not totally unimportant, since the storage bag 12 is actually a carrying bag.

Both the base plate 20 and the clamping plate expediently consist of plastic, for example, the base plate 20 and the clamping plate can be produced as injection moulded parts. The abovementioned fastening unit 38 for tensioning the base plate 20 and the clamping element 21 further comprises a multiplicity of fastening screws 41, which are supported on the base plate 20 or on the clamping plate and which are respectively screwed into other components.

As furthermore shown in the overall view of FIGS. 3 and 4, screw holes 42 are made in the base plate, which open out on the flat underside of the base plate and extend towards the clamping plate in the region of the webs 40 of the base plate into sleeves 43 specifically provided for them, which are additional to the webs 40 on the upper side of the base plate 20. As shown in particular in FIG. 3, screw holes also exist in the clamping plate, into which the fastening screws are screwed.

When tensioning the base plate 20 and the clamping plate, the fastening flaps 35a-d are therefore held by the attachment elements 37 between the underside of the clamping plate and the base plate 20 upper side and are fixedly clamped there by the tensioning of the base plate 20 and the clamping plate.

As shown in particular in FIG. 3, the storage bag 12 has a separation wall 45 extending in a vertical direction 15, dividing the storage space 19 into two storage compartments 44a, 44b.

In the example shown, the separation wall between the front wall 24 and the back wall 25 therefore extends substantially parallel to the front wall 24 and the back wall 25. The separation wall 45 furthermore substantially completely bridges the storage space 19 between the two side walls 22a, 22b.

The separation wall 45 also expediently has a textile body 46, wherein the textile body 46 of the separation wall 45 can also, if necessary, enclose a stiffening structure, for example stiffener plates, so as to stiffen the separation wall 45.

The separation wall 45 is fastened to the bag bottom 16 in the region of its underside 47 facing the bag bottom 16 by means of a separation wall fastening device 48.

In the concrete example, the separation wall 45 is fastened to the bag bottom 16 with a separation wall fastening device 48 materialised as a piping joint.

Such a separation wall fastening device 48 comprises a piping strip 49 arranged on the separation wall 45 and a holding unit 50 arranged on the bag bottom 16 holding the wall section of the separation wall 45 enclosing the piping strip 49.

The clamping plate is the element of the bag bottom 16 that is used to fasten the separation wall 45.

As shown in particular in FIG. 3, the holding unit 50 for the wall section of the separation wall 45 and the piping strip 49 is arranged on the upper side of the clamping plate. The holding unit 50 in the example shown comprises several holding sleeves 51 arranged one after another in the longitudinal direction 23 of the holding bag 12, the holding sleeves consisting of sleeve sides 52 respectively protruding upwards from the upper side of the clamping plate, wherein a slot 53 running in the longitudinal direction is situated between the free ends of the sides 52 of the sleeves. The clear width of the slot 53 is smaller than the diameter of the piping strip 49.

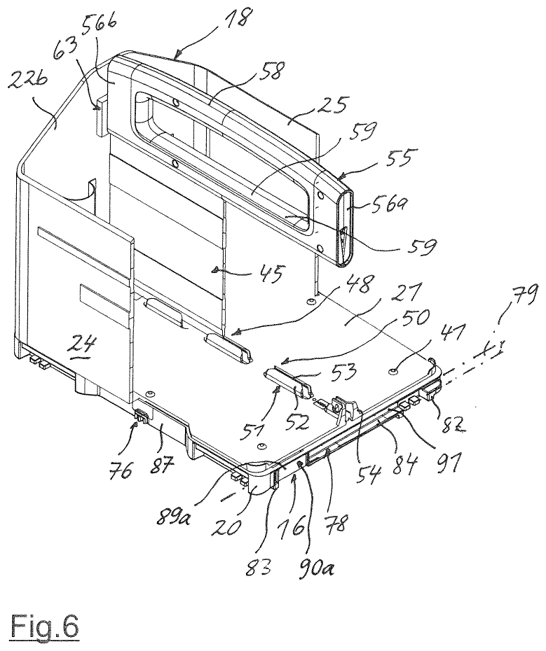

As shown in particular in FIG. 6, the separation wall 45 is fastened by threading the wall section consisting of a textile material, which encloses the piping strip 49, together with the piping strip, from the front end of the clamping plate, wherein the relatively narrow part of the separation wall 45 situated above the piping strip 49 fits through the slot 53. A funnel-shaped insertion aid 54 protruding upwards from the base plate is situated at the front end of the base plate in order to facilitate threading the separation wall 45 together with the piping strip in from the side.

An important aspect is that the storage bag 12 has a carrying handle 55 spanning the storage space 19 and attached to the bag body in the region of the top end 18 of the bag.

As shown in particular in FIGS. 3 and 4, the carrying handle 55 is formed by two handle plates 56a, 56b with their respective open sides put together and joined to each other. The two handle plates 56a, 56b are screwed to the carrying handle 55 by fastening means in the form of fastening screws 85. The carrying handle 55 is designed as a bow handle and has a grip bar 58 extending between two sides 57a, 57b of the handle. The two sides 57a, 57b of the handle are formed by the corresponding sections of the two handle plates 56a 56b when the two handle plates 56a, 56b are screwed together. The grip bar 58 bridges a joining bar 59 that joins the undersides of the two sides 57a, 57b of the handle together. The joining bar forms a hollow space 60, which accommodates a joining rod 62 arranged on the top side 61 of the separation wall 45. The two handle plates 56a, 56b are therefore screwed together when the joining rod 62 is located in a recess formed by one or the other handle plate 56a, 56b, wherein the two recesses of the handle plates 56a, 56b together create the hollow space 60. The separation wall 45 is thereby also joined to the carrying handle 55 by means of a kind of piping joint.

The carrying handle 55 is furthermore joined to the bag circumferential wall 17 by a joining device 63. In the example shown, the joining device 63 has two joining elements 64a, 64b, respectively associated with one of the side walls 22a, 22b, through which elements the carrying handle is fastened at one end to the side wall pediment section 28 of one side wall 22a, and at the other end to the side wall pediment section 28 of the other side wall 22b.

As shown in particular in FIG. 3, each of the joining elements 64a, 64b has a base section 65, which is fastened to the inner side of the side wall pediment section 28, and a fastening flap 66 facing towards the carrying handle 55, in particular orthogonal to the base section 65, the flap being clamped between the two handle plates 56a, 56b of the carrying handle 55, whereby the carrying handle is fastened to the associated pediment of the associated side wall 22a, 22b.

No fastening of the separation wall to the side walls 22a, 22b has been envisaged, but this can also be envisaged if necessary.

As shown in particular in FIG. 1, the storage bag 12 has a carrying strap 67 fastened to the bag circumferential wall 17. In the example shown, the carrying strap is fastened to the outer sides of the side walls 22a, 22b and actually to the side wall pediment sections 28.

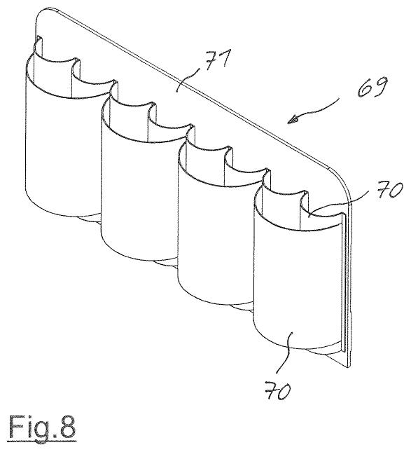

As shown in particular in the overall views of FIGS. 1 and 8, the storage bag 12 has a multiple holding element 69 for holding items such as tools or suchlike, arranged on the inner side of the bag circumferential wall 17 and/or on at least one side face 68a, 68b of the separation wall 45 facing the associated holding compartment 44a, 44b.

In the example shown, such holding elements 69 are situated on the side walls 68a, 68b of the separation wall 45, on the inner side of the front wall 24, on the inner side of the back wall 25 and on the inner sides of the side walls 22a, 22b. If necessary, holding elements 69 can also be arranged on the outer sides, in particular the outer sides of the side walls 22a, 22b. While the two holding compartments 44a, 44b separated by the separation wall 45 are mainly configured for housing loose items, the holding elements 69 offer targeted holding for associated items, tools in particular.

For this, the holding elements 69 have a loop-shaped or pocket-shaped holding section 70, which can be made if applicable from an elastic rubber.

The holding elements 69, in particular some of the holding elements, expediently have a plate-shaped base section 71, such as that shown as an example in FIG. 8. The base section 71 is plate-shaped and is used in conjunction with a joining device 72 for detachably joining the holding element to the associated inner side of the bag circumferential wall 17 and/or to the side face 68a, 68b of the separation wall 45.

The joining device 72 is designed as a reversible quick-release fastener. A textile Velcro fastener is particularly suitable for this purpose. A hook part is expediently fitted to the back side of the base section 71, while a loop part is fitted to the associated inner side of the bag circumferential wall 17 or side face 68a, 68b. It is naturally possible to form the hook part on the bag circumferential wall 17 or separation wall 45 and the associated loop part to the base section 71.

As already described above, it is possible to couple the storage bag 12 with a storage container 13 also belonging to the storage device. In contrast to the storage bag 12, the storage container 13 is a rigid container with a storage casing 73. As shown in particular in FIG. 2, a lower coupling device 74 is situated on the underside of the base plate 20 of the storage bag 12, while an upper coupling device 75 is situated in the region of an upper side of the container casing 73. The two coupling devices 74, 75 are matched together such that the storage bag 12 stacked on the storage container 13 in a vertical direction 15 can be detachably coupled in an inseparable manner by interaction of the upper coupling device 75 with the lower coupling device 74.

In the example shown, the coupling devices 74, 75 comprise projections 76 formed on the underside of the base plate 20 and recesses (not illustrated) formed on the upper side of the container casing, in particular on a cover installed there. In the situation with the storage bag 12 stacked on the storage container 13, the projections and the recesses engage in each other, at least partially, wherein they overlap or interlock across the vertical direction and make an inseparable coupling of the storage bag 12 and the storage container 13. Expediently, the projections 76 are uprights for stowing the storage bag 12 on a base.

The two coupling devices 74, 75 can be joined together by means of a twist lock 81, which at the same time is also used to close the container cover.

The base plate 20 has a rectangular contour, with a front face 87, a back face 88 aligned opposite to it, and two side faces 89a, 89b aligned opposite each other. The front face 87 of the base plate 20 is present as an extension of the front wall 24 of the bag circumferential wall 17, the back face 88 of the base pate is present as an extension of the back wall 25 of the bag circumferential wall 17 and the two side faces of the base plate 20 are present as extensions of the side walls 22a, 22b of the bag circumferential wall 17.

As shown in particular in FIG. 6, the storage bag 12 has a guide device 78 on the outer side of the base plate 20 over which the storage bag 12 can be pulled out and held on a shelf structure 79 belonging to the storage device 11.

For this purpose, the guide device 78 has two guide units 90a, 90b formed on the side faces 89a, 89b of the base plate 20. The guide units 90a, 90b and the remainder of the base plate 20 forms a one-piece component, preferably in a plastic material.

As shown as examples in FIGS. 2 and 6, the guide units 90a, 90b respectively comprise a back stop 82 and a front stop 83.

Each of the guide units furthermore has a recess 91 for accommodating a guide bar 92 formed on the shelf structure 79.

The shelf structure 79 has two shelf rails (not illustrated) respectively associated with one of the guide rails on the base plate 20, each of which has a fixed stop (not illustrated).

The fixed stop interacts with the two stops 82, 83 of the associated guide unit 90a, 90b on the side face 89a, 89b of the base plate 20. The front stop 83 facing the front face 87 of the base plate 20 abuts in the rear retracted position and abuts the fixed stop, which fixes the retracted position. During withdrawal from the shelf structure 79, the storage bag 12 is raised slightly so that the front stop 83 can travel over the end stop. The storage bag 12 can be withdrawn so far from the shelf structure 79 until the back stop 82 abuts the fixed stop, which fixes the maximum extended position.

The guide bars 92 of the shelf structure 79 accommodated in the respective recesses stabilise the storage bag 12 during withdrawal. The two stops of a respective guide unit 90a, 90b of the base plate are situated under the recess 91.

1. A storage device comprising a storage bag, which has a bag body with a bag bottom and a bag circumferential wall protruding in a vertical direction from the bag bottom, which together delimit a storage space open at the top of the bag, and with a carrying handle spanning the storage space and attached to the bag body in the region of the top of the bag, wherein the bag circumferential wall is fastened to the bag bottom, and wherein the bag bottom has a base plate and the storage bag has a guide device on the outer side of the base plate, over which the storage bag can be pulled out in a pulling-out direction, able to be held in a shelf structure belonging to the storage device.

2. The storage device according to claim 1, wherein the base plate has a rectangular contour, with a front face, a back face arranged opposite the front face and two side faces arranged opposite each other.

3. The storage device according to claim 2, wherein the guide device has two guide units formed on the side faces of the base plate.

4. The storage device according to claim 3, wherein the guide units are formed in a single piece with the remainder of the base plate.

5. The storage device according to claim 3, wherein the base plate and the guide units consist of a plastic material.

6. The storage device according to claim 3, wherein the guide units each have a back stop and a front stop for attaching the storage bag in a defined rear position and when moved in a pulling-out direction, in a defined front position.

7. The storage device according to claim 3, wherein the guide units each have a recess for accommodating a guide bar formed on the shelf structure.

8. The storage device according to claim 7, wherein the front stop and the back stop are arranged below the recess.

9. The storage device according to claim 7, further comprising, in addition to the storage bag, at least one storage container having a storage casing, wherein a lower coupling device is arranged on the base plate of the storage bag and an upper coupling device is arranged in the region of a top side of the container casing of the storage container, wherein these two coupling devices are matched together such that the storage bag stacked on the storage container in a vertical direction can be detachably coupled together in an inseparable manner by interaction of the upper coupling device of the storage container with the lower coupling device of the storage bag.

10. The storage device according to claim 9, wherein the lower coupling device on the base plate of the holding bag has a locking projection arranged on the front face of the base plate and the upper coupling device on the container casing has a twist lock, which can be moved for locking in locking engagement with the locking projection.

11. The storage device according to claim 9, wherein the bag bottom has a clamping element attached on the upper side of the base plate, wherein a fastening flaps arrangement in a bending flexible material protruding inwards on the bag circumferential wall is arranged on its underside, and is fixedly clamped between the base plate and the clamping element.

12. The storage device according to claim 9, wherein the bag circumferential wall has a textile body.

13. The storage device according to claim 11, wherein the fastening flaps arrangement has a plurality of fastening flaps formed separately from each other.

14. The storage device according to claim 11, wherein the clamping element is formed as a clamping plate.

15. The storage device according to claim 11, wherein the bag bottom has a fastening device for reciprocal tensioning of the base plate with the clamping element, wherein the fastening device preferably has a multiplicity of fastening screws, which are supported on the base plate or on the clamping element and into which other components are respectively screwed.

16. The storage device according to claim 11, wherein the bag circumferential wall forms a rectangular contour and is formed from two side walls arranged opposite each other, a front wall and a back wall.

17. The storage device according to claim 11, further comprising a plurality of holding elements for holding items arranged on the inner side of the bag circumferential wall and/or on at least one side face of the separation wall facing the associated holding compartment.

18. The storage device according to claim 17, wherein the holding elements each have a holding section formed in the shape of a loop or pocket.

19. The storage device according to claim 17, wherein the holding elements each have a plate-shaped base section, by means of which the holding element can be detachably fastened or is detachably fastened by a joining device to the associated inner side of the bag circumferential wall and/or the side face of the separation wall.

20. The storage device according to claim 19, wherein the joining device is formed as a reversible quick-release fastener.

21. The storage device according to claim 19, further comprising a carrying strap fastened to the bag circumferential wall.
